(19) United States
(12) Patent Application Publication
(10) Pub. No.: US 2010/0138698 A1
(43) Pub. Date: Jun. 3, 2010

(54) REASONING ARCHITECTURE

(75) Inventors: Jürgen Angele, Herxheim (DE); Jürgen Baier, Karlsruhe (DE)

Correspondence Address: FOLEY & LARDNER LLP, 111 HUNTINGTON AVENUE, 26TH FLOOR, BOSTON, MA, 02199-7610, US

(73) Assignee: ONOTPRISE GMBH

(21) Appl. No.: 12/598,873

(22) PCT Filed: May 13, 2008
(86) PCT No.: PCT/EP08/03840

§ 371 Date: Nov. 4, 2009

(30) Foreign Application Priority Data
May 10, 2007 (EP) 07009421.4

(51) Int. Cl. G06F 11/07; G06N 5/04

(52) U.S. Cl. 714/37; 706/47; 706/50; 714/E11.024

(57) ABSTRACT

An inference engine is described with improved speed in evaluating queries posed to a data structure based on an ontology with a declarative set of rules. The inference engine comprises: rule rewriters, a rule compiler, and an operator net. The operator net comprises a graph with operators as nodes and with connections between the operators as edges of the graph. The operators serve for: retrieving facts; matching facts and variables in rules; expressing rule bodies and rule heads; expressing negations; and expressing logical AND operations between rule bodies. The operator net is a very general and versatile representation of the rules and queries. It also lends itself easily to multithreading and debugging.

### BACKGROUND OF THE INVENTION

Inference engines are capable of answering queries by logical conclusion or finding new information hidden in related data.

The operation of an Inference engine will first be explained briefly.

As a rule, an Inference engine is based on a data processing system or a computer system with means for storing data. The data processing system has a query unit for determining output variables by accessing the stored data. The data are allocated to predetermined classes which are part of at least one stored class structure forming an ontology.

### Ontologies

In computer science, an ontology designates a data model that represents a domain of knowledge and is used to reason about the objects in that domain and the relations between them.

The ontology preferably comprises a hierarchical structure of the classes. Within the hierarchical structure, each class can have exactly one father class, expect for the root class that has no father class. Another word for father class is super class. In general, there is only a simple inheritance of characteristics in such a case. In general, the class structure can also be arranged in different ways, for example as acyclic graph in which multiple inheritances can also be permitted.

To the classes, attributes are allocated which can be transmitted within a class structure. Attributes are features of a class. The class “person” can have the attribute “hair colour”, for example. To this attribute, different values (called “attribute values”) are allocated for different actual persons (called “instances”), e.g. brown, blond, black, etc.

Sometimes in the literature, the classes are called “categories” or “concepts” and the attributes are called “properties”.

A class can also have a synonym allocated to it, i.e. more than one name.

Also, a class can have a relation allocated to it. An example of a relation could be that a person is married to another person. Thus, relations define relations between elements of the class structure.

Classes, attributes, synonyms, relations, that is to say relations between elements and allocations, in short everything from which the ontology or the class structure is built up are called elements of the class structure.

The query unit contains an Inference engine or inference unit by means of which rules and logic expressions can be evaluated. The rules combine elements of the class structure and/or data. A common language example of a rule would be: If a person is male and has a child, this person is a father. Generally, the rules are arranged as a declarative system of rules. An important property of a declarative system of rules consists in that the results of an evaluation do not depend on the order of the definition of the rules.

The rules enable, for example, information to be found which has not been described explicitly by the search terms. The inference unit even makes it possible to generate, by combining individual statements, new information which was not explicitly contained in the data but can only be inferred from the data (see section query below).

An ontology regularly contains the following elements:
a hierarchical structure of classes, that can be understood by the end user,
attributes associated to the classes and their inheritance,
relations between classes,
a declarative system of logical rules, containing further knowledge,
an inference unit by evaluating the rules for answering queries and for generating new knowledge,
a formal logical basis, e.g. based on description logic, which in turn is based on predicate logic (see e.g. http://en.wikipedia.org/wiki/Description_logic: “Description logics (DL) are a family of knowledge representation languages which can be used to represent the terminological knowledge of an application domain in a structured and formally well-understood way. The name description logic refers, on the one hand, to concept descriptions used to describe a domain and, on the other hand to the logic-based semantics which can be given by a translation into firstorder predicate logic. Description logic was designed as an extension to frames and semantic networks, which were not equipped with a formal logic-based semantics. Description logic was given its current name in the 1980s. Previous to this it was called (chronologically): terminological systems, and concept languages. Today description logic has become a cornerstone of the Semantic Web for its use in the design of ontologies.”
a semantic for assigning meaning to the classes, and
an ontology language to formulate the ontology, e.g. OWL, RDF or F-Logic.

Thus, ontologies are logical systems that incorporate semantics. Formal semantics of knowledge-representation systems allow the interpretation of ontology definitions as a set of logical axioms. E.g. we can often leave it to the ontology itself to resolve inconsistencies in the data structure. E.g., if a change in an ontology results in incompatible restrictions on a class, it simply means that we have a class that will not have any instances (is “unsatisfiable”). If an ontology language based on Description Logics (DL) is used to represent the ontology (e.g. OWL, RDF or F-Logic), we can e.g. use DL reasoners to re-classify changed classes based on their new definitions.

It should be clear to one skilled in the art, that an ontology has many features and capabilities that a simple data schema, database or relational database is lacking.

### Introduction to F-Logic

For the formulation of queries, often the logic language F-Logic is a useful ontology language [see, e.g., J. Angele, G. Lausen: “Ontologies in F-Logic” in S. Staab, R. Studer (Eds.): Handbook on Ontologies in Information Systems. International Handbooks on Information Systems, Springer, 2003, page 29]. In order to gain some intuitive understanding of the functionality of F-Logic, the following example might be of use, which maps the relations between well-known biblical persons.

First, we define the ontology, i.e. the classes and their hierarchical structure as well as some facts:
man::person.
woman::person.
abraham: man.
person[fatherIs=>man; motherIs=>woman;
sonIs=>>man; daughterIs=>>woman].
sarah: woman.
isaac: man[fatherIs->abraham; motherIs->sarah].
ishmael: man[fatherIs->abraham; motherIs->hagar: woman].
jacob: man[fatherIs->isaac; motherIs->rebekah: woman].
esau: man[fatherIs->isaac; motherIs->rebekah].

Obviously, some classes are defined: “man” and “woman” which are sub-classes of “person”. E.g., Abraham is a man. The class “man” has the properties/relations “fatherIs” and “motherIs”, which are indicating the parents and are designated by the sign “=>”. The sign “=>” indicates that there is at maximum one father and one mother. “=>>” indicates that for these properties/relations there might be more than one son or daughter. E.g., the man Isaac has the father Abraham and the mother Sarah. In this particular case, the properties are object properties.

Although F-Logic is suited for defining the class structure of an ontology, nevertheless, in many cases, the ontology languages RDF or OWL are used for these purposes.

Further, some rules are given, defining the dependencies between the classes:
FORALL X,Y X[sonIs->>Y]<-Y:man[fatherIs->X].
FORALL X,Y X[sonIs->>Y]<-Y:man[motherIs->X].
FORALL X,Y X[daughterIs->>Y]<-Y:woman[fatherIs->X].
FORALL X,Y X[daughterIs->>Y]<-Y:woman[motherIs->X].

Rules written using F-Logic consist of a rule header (left side) and a rule body (right side). Thus, the first rule in the example given above means in translation: If Y is a man, whose father was X, then Y is one of the (there might be more than one) sons of X. The simple arrow “->” indicates that, for a given datatype or object property, only one value is possible, whereas the double-headed arrow “->>” indicates that more than one value might be assigned to a property.

Finally, we formulate a query, inquiring for all women having a son whose father is Abraham. In other words: With which women did Abraham have a son?
FORALL X,Y<-X:woman[sonIs->>Y[fatherIs->abraham]].

The syntax of a query is similar to the definition of a rule, but the rule header is omitted.

The answer is:
X=sarah
X=hagar

### Queries and Inference

Let us consider another example of a query. A user would like to inquire about the level of knowledge of a person, known to the user, with the name “Mustermann”. For one particular categorical structure, a corresponding query could be expressed in F-Logic as follows (see below for another more exhaustive example):
FORALL X,Y<-X:person[name->Mustermann; knows->>Y].

A declarative rule that can be used to process this query can be worded as follows: “If a person writes a document, and the document deals with a given subject matter, then this person has knowledge of the subject matter.” Using F-Logic, this rule could be expressed in the following way (see below):
FORALL X,Y,Z Y[knows->>Z]<-X:document[author->>Y:person] AND X[field->>Z].

The categories “persons” and “document” from two different categorical structures are linked in this way. Reference is made to the subject of the document, wherein the subject of the document is allocated as data to the attribute “subject” of the category “document”.

The areas of knowledge of the person with the name “Mustermann” are obtained as output variables for the above given query.

For implementing this example, several logic languages can be used. As an example, an implementation using the preferred logic language F-Logic will be demonstrated.

/* ontology */
author:: person. field:: science.
biotechnology: field.
physics: field.
chemistry: field.
document[author=>>author; field=>>field].
person[authorOf=>>document].

In this first section, the ontology itself is defined: The data contain documents with two relevant attributes—the author and the scientific field.

```
/* facts */
Paul: person.
Anna: person.
Mustermann: person.
doc1: document[field->>biotechnology; author->>Paul].
doc2: document[field->>biotechnology; author->>Paul].
doc3: document[field->>chemistry; author->>Paul].
doc100: document[field->>physics; author->>Anna].
doc101: document[field->>physics; author->>Anna].
doc200: document[field->>biotechnology;
        author->>Mustermann].
doc201: document[field->>biotechnology;
        author->>Mustermann].
doc202: document[field->>biotechnology;
        author->>Mustermann].
```

In this section, we defined the facts of the ontology. There are eight documents (named doc1, . . . , doc202) with the given fields of technology and the given authors.

/* query */
FORALL X <- Mustermann[knows->>X:field].

This section is the actual query section. Using the declarative rules defined in the previous section, we deduce, by inference, the fields of experience of the author “Mustermann”.

In the inference unit, the above query is evaluated using the above rule. This is shown as a forward chaining process meaning that the rules are applied to the data and derived data as long as new data can be deduced.

Given the above facts about the documents and the above given rule:
FORALL X,Y,Z Y[knows->>Z]<-X:document[author->>Y:person] and X[field->>Z].
   first all substitutions of the variables X, Y and Z are computed which make the rule body true:
X=doc1, Y=Paul, Z=biotechnology
X=doc2, Y=Paul, Z=biotechnology
X=doc3, Y=Paul, Z=chemistry
X=doc100, Y=Anna, Z=physics
X=doc101, Y=Anna, Z=physics
X=doc200, Y=Mustermann, Z=biotechnology
X=doc201, Y=Mustermann, Z=biotechnology
X=doc202, Y=Mustermann, Z=biotechnology

After that the variables in the rule head are substituted by these values resulting in the following set of facts:
Paul[knows->>biotechnology].
Paul[knows->>chemistry].
Anna[knows->>physics].
Mustermann[knows->>biotechnology].

In the next step for our query
FORALL X<-Mustermann[knows->>X:field].
   the variable substitutions for X are computed which make the query true:
X=biotechnology

This variable substitution represents the result of our query. The result is preferably output via an input/output unit.

The example shows that the query not only obtains information stored in the database system explicitly. Rather, declarative rules of this type establish relations between elements in database systems, such that new facts can be derived, if necessary.

Thus, additional information, which cannot explicitly be found in the original database, is “created” (deduced) by inference: In the original database (which, in this simple example, has been “simulated” by creating the ontology in F-Logic, see above), there is no such information as “knowledge” associated (e.g. as an attribute) to a certain person. This additional information is created by inference from the authorship of the respective person, using known declarative rules.

Processing a query with the term “biotechnology” in a traditional database system would require that the user already has detailed information concerning the knowledge of Mustermann. Furthermore, the term “biotechnology” would have to be found explicitly in a data record allocated to the person Mustermann.

Processing a query with the term “knowledge” in principle would not make sense for a traditional database system because the abstract term “knowledge” cannot be allocated to a concrete fact “biotechnology”.

The example shows that, compared to traditional database systems, considerably less pre-knowledge, and thus also less information, is required for the computer system according to the invention to arrive at precise search results.

### Dynamic Filtering

The following illustrates in more detail the way the inference unit evaluates the rules to answer the queries.

The most widely published inference approach for F-Logic is the alternating fixed point procedure [A. Van Gelder, K. A. Ross, and J. S. Schlipf: “The well-founded semantics for general logic programs”; Journal of the ACM, 38(3):620-650, July 1991]. This is a forward chaining method (see below) which computes the entire model for the set of rules, i.e. all facts, or more precisely, the set of true and unknown facts. For answering a query the entire model must be computed (if possible) and the variable substitutions for answering the query are then derived. Forward chaining means that the rules are applied to the data and derived data as long as new data can be deduced.

Alternatively, backward chaining can be used. Backward chaining means that the evaluation has the query as starting point and looks for rules with suitable predicates in their heads that match with an atom of the body of the query. The procedure is recursively continued. Also backward chaining looks for facts with suitable predicate symbols.

An example for a predicate for the F-Logic expression Y[fatherIs->X] is father(X,Y), which means that X is the father of Y. “father” is the predicate symbol. The F-Logic terminology is more intuitive than predicate logic. Predicate logic, however, is more suited for computation. Therefore, the F-Logic expressions of the ontology and query are internally rewritten in predicate logic before evaluation of the query.

In the preferred embodiment, the inference engine performs a mixture of forward and backward chaining to compute (the smallest possible) subset of the model for answering the query. In most cases, this is much more efficient than the simple forward or backward chaining evaluation strategy.

The inference or evaluation algorithm works on a data structure called system graph (see e.g. FIG. 1). This graph represents the set of rules and their dependencies. Every atom of the rules (i.e. head or body, left hand or right hand side, or part of the body) is represented as a vertex of the graph. All atoms in the body of a rule—which may be connected by AND only—are connected to the head atom (header) of the rule by a connection or an edge. Every head atom, in turn, is upwardly connected to all body atoms with the same predicate symbol. Let's have a look at an example:

/* rules */
FORALL X,Y r(X,Y) <- p(X,Y) AND r(Y,b).
FORALL X,Y r(X,Y) <- s(X,Y).
/* facts */
q(a). p(b,b). p(a,b). r(a,a). r(b,b). s(e,f).
/* query */
FORALL Y <- r(a,Y).

This example is illustrated in FIG. 1.

The bottom-up evaluation using the system graph may be seen as a flow of data from the sources (facts) to the sinks (query) along the edges of the graph.

If a fact q(a1, . . . , an) flows from a head atom of rule r to a body atom q(b1, . . . , bn) of rule r′ (along a solid arrow) a match operation takes place. This means that the body atom of rule r′ has to be unified with the facts produced by rule r. All variable substitutions for a body atom form the tuples of a relation, which is assigned to the body atom. Every tuple of this relation provides a ground term (variable free term) for every variable in the body atom. To evaluate the rule, all relations of the body atoms are joined and the resulting relation is used to produce a set of new facts for the head atom. These facts again flow upwards in the system graph.

For the first rule
FORALL X,Y r(X,Y)<-p(X,Y) AND r(Y,b).
   there are four possible input combinations, two facts for p(X,Y), namely p(b,b) and p(a,b), multiplied by two facts for r(Y,b), namely r(a,a) and r(b,b). Only the fact r(b,b) matches r(Y,b) in the rule, which leads to Y being b in the rule. With Y being b, there are two possible facts matching p(X,Y), namely p(b,b) and p(a,b). Thus, two new facts can be derived from the first rule on the left-hand side, namely
r(b,b)<-p(b,b) AND r(b,b)
   and
r(a,b)<-p(a,b) AND r(b,b).

On the right hand side of the system graph according to FIG. 1, we see that the fact s(e,f) leads to r(e,f), applying the second rule. r(e,f), however, cannot be substituted into the query
FORALL Y<-r(a,Y).
   since ‘a’ does not match ‘e’.

Only the fact r(a,b) derived with the first rule matches the query leading to the answer
Y=b.

This evaluation strategy corresponds to the naive evaluation [J. D. Ullman: “Principles of Database and Knowledge-Base Systems”; vol. I, Computer Sciences Press, Rockville, Md., 1988] and realizes directly the above mentioned alternating fixed point procedure. Because the system graph may contain cycles (in case of recursion within the set of rules) semi naive evaluation [J. D. Ullman: “Principles of Database and Knowledge-Base Systems”; vol. I, Computer Sciences Press, Rockville, Md., 1988] is applied in the preferred embodiment to increase efficiency.

The improved bottom-up evaluation (forward chaining) of the example mentioned above is shown in FIG. 2. The facts flowing to a vertex are shown in the bubble attached to the vertex.

FIG. 2 exemplifies that facts are created for the vertices although they are useless for answering the posed query. For instance the fact p(b,b) (vertex 11) flowing to the body vertex p(X,Y) (vertex 2) cannot contribute in any way to the answer, because in the query r(a,Y) only instances of the variable X which are equal to the constant a are relevant. Such useless facts in turn produce new useless facts in the subsequent evaluation.

The key idea of dynamic filtering is to abort the flow of useless facts as early as possible (i.e. as close to the sources of the graph as possible) attaching so-called blockers to the head-body edges of the graph. Such a blocker consists of a set of atoms. A blocker lets a fact pass, if there exists an atom within the blocker which matches with the fact.

For instance the blocker B1,2 between vertex 1 and vertex 2, B1,2={p(a,Y)} prevents the fact p(b,b) from flowing to the vertex 2. Additionally, the creation of the fact r(b,b) for vertex 3 is prevented by a corresponding blocker (not shown) between vertex 7 and vertex 3. Similarly, the blocker B4,5={s(a,Y)} between vertex 4 and vertex 5 blocks the flow of facts on the right-hand side of the system graph.

Thus, the answer to the posed query r(a,Y) remains the same, although the amount of facts flowing through the graph is reduced.

The blockers at the edges of the system graph are created by propagating constants within the query, within the rules, or within already evaluated facts downwards in the graph. For instance the blocker B1,2={p(a,Y)} is determined using the constant a at the first argument position of the query r(a,Y). This blocker is valid because for the answer only facts at vertex 3 are useful containing an ‘a’ as first argument. So variable X in the first rule must be instantiated with ‘a’ in order to be useful for the query.

The blockers at the edges of the system graph are created during the evaluation process in the following way. First of all, constants within the query and within the rules are propagated downwards in the graph. Starting at the query or at a body atom, they are propagated to all head atoms, which are connected to this atom. From the head atoms they are propagated to the first body atom of the corresponding rule and from there in the same way downwards. In propagating the constants downwards, they produce new blocker atoms for the blockers at the sources.

Alternatively, blockers can also be applied in the upper layers of the system graph, but this does not lead to an significant improvement of the performance. Therefore, blockers are preferably applied at the sources of the graph.

### FIELD OF THE INVENTION

For the performance of an inference engine, i.e. the speed of evaluation, not for the result, several conditions are crucial. On one hand, there is the sequence of the evaluation of rule bodies. On the other hand, it is important not to pursue branches of the reasoning with little chances of being relevant, as in the above described case of dynamic filtering.

### BRIEF SUMMARY OF THE INVENTION

It is an object of the present invention to optimize the performance of an inference engine.

This aim is achieved by the inventions as claimed in the independent claims. Advantageous embodiments are described in the dependent claims.

Even if no multiple back-referenced claims are drawn, all reasonable combinations of the features in the claims shall be disclosed.

The object of the invention is also achieved by a method. In what follows, individual steps of a method will be described in more detail. The steps do not necessarily have to be performed in the order given in the text. Also, further steps not explicitly stated may be part of the method.

### Overall Reasoning Architecture

The inference engine is a deductive main memory based reasoning system. A rough dataflow diagram of the reasoning kernel is shown in FIG. 3.

If an F-Logic rule is added to inference engine, the rule is compiled with the F-Logic Compiler to the internal format. The internal format represents a complex F-Logic rule in a set of normal rules using the Lloyd-Topor transformation [J. W. Lloyd and R. W. Topor. Making Prolog more expressive. Journal of Logic Programming, 1(3):225-240, 1984.]. These normal rules are added to the intensional database (IDB). This intensional database may either be a data structure in main memory or—as another option—may be a really persistent database like a commercial relational database.

If an F-Logic fact is added to the system, this fact again is compiled by the F-Logic compiler and then stored as a ground literal in the extensional database. In the same way as the intensional database the extensional database can be a main memory data structure or a persistent relational database.

The most interesting thing happens if a query is sent to the inference engine. After compiling the query a selection process takes place. The intensional database maintains a so called rule graph (similar to the system graph of FIGS. 1 and 2). This rule graph describes the dependencies between rules, i.e. which rule head unifies with which rule bodies. The query is used for cutting out that sub-graph out of the rule-graph which is connected to the query.

The resulting set of rules and the query is processed by a set of rewriters. These rewriters modify the set of rules in a way that the same answers are generated, but the evaluation may be processed faster. A well-known example for such a rewriter is MagicSet rewriting [J. Ullmann: Principles of Database and Knowledge-Base Systems, Volume II, Computer Science Press, 1989]. There are other simpler rewriters which eliminate redundant literals in a rule, which add restricting literals etc.

### Operator Net

After that step, a rule compiler compiles the set of rules and the query into an operator net. The operator net contains the elementary operations and connects them in an appropriate manner to perform the inference described by the rules. An edge in the operator net describes the data flow, i.e. the result of an operator flowing to another operator. An example of an operator net will be explained in connection with FIG. 5 (see below). It shows the directed dependencies of the different operators.

The operator net consists of a graph of operators. Each operator receives tuples of terms, processes them and sends the results into the graph. Usually there are operators for:
joining tuple sets (which corresponds to logical AND),
operators for negation (which corresponds to logical NOT),
operators for matching (which corresponds to connections between heads and bodies of rules and which perform the matching of facts and variables),
operators for built-ins,
operators for accessing the data base,
and some more

The inference engine provides different evaluation methods which create different operator nets with different operators.

Examples for such evaluation methods are bottom-up evaluation, dynamic filtering, and SLD [J. D. Ullman: “Principles of Database and Knowledge-Base Systems”; vol. II, Computer Sciences Press, Rockville, Md., 1989]. This architecture clearly separates the handling of rules from the evaluation and allows to easily develop new evaluation methods with new operators.

In addition the operators and sub-nets may be processed independently from each other, allowing a multiprocessor/multicore architecture of the inference engine. Every processing of an operator may be executed in a separate independent thread allowing maximal parallelization of the execution.

Finally the evaluation of the operator net creates a set of result tuples. Every result tuple represents a substitution of the variables of the query. These substitutions are finally sent back to the client.

In the next sub-sections the different steps sketched here are refined and presented with additional examples.

### Selection of the Sub-Rule-Graph

The inference engine internally deals with so-called normal rules. A normal rule is a horn rule with possible negated literals only in the body:
H<-B₁ & . . . & Bₙ & not N₁ & . . . & not Nₘ

Where H, Bᵢ are positive literals and not Nⱼ are negated literals. A literal in turn consists of a predicate symbol p and terms tₖ as arguments:
p(t₁, . . . , tₖ)

A term t may either be a constant or a function or a variable. A function consists of a function symbol f and terms as arguments. A function in turn is a term:
f(t₁, . . . , t₁)

In a rule graph (cf. FIG. 4) the different rules are the nodes. A rule graph is an abbreviated version of a system graph. Node r1 is connected to node r2 if the head literal of r1 unifies with one body literal in r2. Let's illustrate this in an example. Given the rules:

| | |
|---|---|
| FORALL X,Y p(f(X),Y) <- q(X,Y) & p(f(X),Y). | // rule 1 |
| FORALL X p(f(X),X) <- r(X) & s(X). | // rule 2 |
| FORALL X t(X) <- u(X). | // rule 3 |
| FORALL X <- p(X,1). | // rule 4 |

This results in the rule graph depicted in FIG. 4.

The selection process for the sub-rule-graph now searches for rules connected to the query (rule 4) and rules out all other rules, thus very often strongly reducing the set of rules to be considered. So in our running example rules 1, 2, and 4 are selected for the further evaluation process.

### Rewriting the Rules

As mentioned above, a set of rewriters is applied. Every rewriter changes the set of rules. The goal is to transform the rules into another set of rules which delivers the same answer to the query but can be evaluated much faster. In the following we give an example for such a rewriter. Given the following rules:

| | |
|---|---|
| FORALL X,Y p(X,Y) <- q(X,Y) & t(f(X),Y). | // rule 1 |
| FORALL X p(X,X) <- r(X) & s(X). | // rule 2 |
| FORALL X,Y <- p(X,Y) & X < 5. | // rule 3 |

Basically a rule graph as depicted in FIG. 4 may be seen as a graph where the facts flow along from the facts store (not shown), i.e. the EDB of FIG. 3, to the query. So in our new example, if there are facts for the predicates r and s, resp. r(1), r(2), s(a), these facts flow to rule 2 and produce the new fact p(1,1) etc. On the other hand we see that rule 3 restricts the values for the answer by the condition X<5. So for the performance of the evaluation it is useful to apply this restriction as early as possible. So we could rewrite the set of rules to the following set of rules:

| | |
|---|---|
| FORALL X,Y p(X,Y) <- q(X,Y) & t(f(X),Y) & X < 5. | // rule 1′ |
| FORALL X p(X,X) <- r(X) & s(X) & X < 5. | // rule 2′ |
| FORALL X,Y <- p(X,Y). | // rule 3′ |

It is obvious that this set of rules delivers the same result as the original set. Additionally, the condition that X<5 is applied as early as possible and thus restricts the instances as early as possible, resulting in higher performance of the evaluation.

In the literature we find a lot of other rewriting techniques for improving the performance, e.g. MagicSets [J. Ullmann: Principles of Database and Knowledge-Base Systems, Volume II, Computer Science Press, 1989].

### Compiling Rules

After rewriting the rules, a rule compiler compiles the rules into the operator net. The operator net provides different operators for different purposes. For instance it provides
join-operators to perform an “AND” in a rule body,
match-operations to match the results of a rule to the body of a connected rule
etc. (see above).

Additionally it describes also the sequence in which different parts are evaluated. An operator net is very close to a data flow diagram. It usually does not need any additional control flow for the sequence of the evaluation of processes (operations). Let us illustrate this with an example:

/* rules */
FORALL X p(X,X) <- r(X) & s(X).
/* facts */
r(1). r(2). r(3). s(1). s(2).
/* query */
FORALL X <- p(X,1).

If we assume pure bottom-up evaluation the resulting operator net is very simple. It is depicted in FIG. 5.

The operator net is a graph like all other graphs depicted in FIGS. 1, 2 and 4. All these graphs can be stored in well-known data structures for graphs, either in main memory or in persistent memory.

From the EDB the instances r(1), r(2), and r(3) for the r predicate flow over the F/r node to the body literal node r(X). F is an operator for retrieving facts from the EDB, e.g. by generating an SQL query. F/r retrieves all facts relating to the predicate r.

The M node performs a match operation, which selects tuples and produces appropriate substitutions for the variables in r(X). In our case nothing has to be selected and we have three possible substitutions for variable X: {X/1, X/2, X/3}.

The retrieved data—like all other retrieved or derived data—are stored in a suitable data structure with the node r(x). In this example, the retrieved data have the form of a tuple, a table or a set. Preferably, all retrieved or derived data are treated as sets and are stored with the corresponding nodes.

The r(X) node is a move operator sending the variable substitutions to the connected nodes.

In the same way the instances for the s predicate s(1), s(2) flow from the EDB to the s(X) node resulting in the substitutions {X/1, X/2}. This node is a join-operator (logical AND) which joins its two inputs resulting in the substitutions {X/1, X/2}.

The results are again sent into the operator net and reach the match operation. This match operation requires X to be 1, which is true only for the first substitution X/1. Thus this substitution passes the match operation and reaches the query node p(X,1). So finally the substitution X/1 is the result of that query.

To give a more intuitive example consider the following. Let the predicates from the above example take the meaning
r=male and
s=parent
p=father
p(X,a)=X is father in country a

Facts can be given:
male(Muller)
parent (Meier)
   meaning that Muller is male. Also, Meier is a parent, i.e. has a child.

Let us ask for all German fathers in an example. We then can write:

/* rules */
FORALL X father(X,Germany) <- male(X) & parent(X).
/* facts */
male(Muller). male(Meier). male(Schmidt).
parent(Muller). parent(Meier).
/* query */
FORALL X <- father(X,Germany).

The rule obviously states that a male parent is called father.

Substituting for r(X) using the operators F/r and M we find that Muller, Meier and Schmidt are male human beings. At the same time, F/s shows that Muller and Meier are parents—not Schmidt. Joining male(X) and parent(X) we find that Muller and Meier are male and parents, Schmidt is male but not a parent. Thus, the result of the join operation is {X/Muller, X/Meier}.

With the final match operator M of FIG. 5 we find that Muller and Meier are fathers in Germany.

The strong advantage of separating the operator net from the rule graph and thus the rules itself is that the operator net allows having different rule compilers which compile the set of rules into different operator nets. For instance the inference engine according to an advantageous embodiment includes a rule compiler for Top-Down, Bottom-up, SLD, or Dynamic Filtering reasoning. The operator net was designed to allow easy implementation of these different evaluation strategies. This flexibility is a substantial advantage over other reasoning engines which only support a single strategy.

The operator net is a very general and versatile representation of the elementary operations for inferencing and their data flow. It also lends itself easily to multithreading and debugging.

The operator net evaluation is a very flexible mechanism which allows to employ totally different evaluation strategies within a single evaluation framework. Especially the ability to switch between pure Bottom-Up evaluation (naive and semi-naive), pure Top-Down evaluation (SLD) and mixed evaluation (Dynamic Filtering) is a very powerful feature.

### Operator Net Evaluation

The inference engine is a normal-logic reasoning [T. Przymusinksi. The well-founded semantics coincides with the three-valued stable semantics. Fundamenta Informaticae, 13(4):445-464, 1990.] engine which supports the wellfounded semantics [A. Van Gelder, K. A. Ross, and J. S. Schlipf: “The well-founded semantics for general logic programs”; Journal of the ACM, 38(3), pages 620-650, July 1991]. This means it supports normal programs which may contain function symbols, and negation (stratified and wellfounded). The term programs designates a set of logical rules.

In addition to the components depicted in FIG. 3, the inference engine further has the following major components or performs the following steps (depicted in FIG. 6):
a program evaluator which checks the program characteristics and decides which evaluation strategy should be used for a specific query
a framework for different evaluation strategies (evaluation methods)
a set of rewriters for optimization (e.g. unfolding)
a framework for different rulecompilers
an operator net evaluator which evaluates the compiled operator nets
a framework for different operator implementations

The first step in FIG. 6 is to check the characteristics of the program, i.e. the set of rules. Depending on these characteristics and on the available evaluation methods a strategy is chosen.

Then the evaluator applies multiple program rewriters (most of them are for optimizing the program).

The concrete evaluation strategy will then further prepare the program (e.g. the MagicSets strategy will apply the MagicSets transformation at this point [Beeri C., R. Ramakrishnan: “On the power of magic”; in Proc. Sixth ACM Symp. on Principles of Database Systems, pp. 269-283 (1987)]). Note that some evaluation methods are able to proceed without further preparation.

After the preparation step is done the prepared program will be compiled into the suitable operator net by a rulecompiler. The rulecompiler is a part of the evaluation strategy and is provided by the concrete evaluation method. Typically each evaluation strategy implements its own rule compiler.

The compiled operator net will then be evaluated and the results will be returned to the user. Note that the operator net evaluation is driven by the operator net evaluator. The operator net evaluation is independent of the evaluation strategy, but the data flow between the operators strongly depends on the evaluation method.

### The Program Evaluator

This component is responsible for checking the program characteristics. The inference engine uses the following characteristics:
Is the program bottom-up evaluable?
Does the program contain function symbols?
Does the program contain wellfounded or stratified negations?
Do we need to create explanations?

The program evaluator is also responsible to apply some program rewriters (most of them are for optimizing the program).

### The Rule Compilers

A rule compiler implements an interface which allows compiling single rules or whole programs. The rule compilers use a set of operators; e.g. join or match operators.

The rule compilers are responsible for connecting the operators. When we have a Bottom-Up evaluation method then the Bottom-Up rule compiler connects rule output operators to body operators of other rules. When we have a Top-Down evaluation, then the rule output operators must also be connected to the body operators of other rules, but additional connections between the body operators and the input operators of other rules must be created. This will be explained in more detail below.

### The Operator Net Evaluator

The operator net evaluator gets a compiled operator net and evaluates it. To this end, first all data source operators will be notified to push their data into the operator net using e.g. the F/r operator as explained above. Then the operafor queue which queues the elementary operations will be evaluated until no new facts are generated.

### How a Program is Compiled to an Operator Net

When a query is posed the inference engine first selects the rules which are needed to evaluate the query by choosing the corresponding sub-rule graph or sub-operator net. The result of this rule selection is a program which consists of an intensional database (IDB) and an extensional database (EDB). Now the chosen evaluation method prepares the program (which means it might be rewritten). After the program is prepared the rule compiler of the evaluation strategy compiles the program rule by rule and connects the rules. The result is an operator net, which can then be evaluated.

The rule compilation is best explained by an example. When we have the following rule:
RULE myrule: FORALL X,Y p(X,Y)<-q(X,Y) AND r(X,Y).

Then each body literal is compiled to a join operator and the two join operators are connected (see FIG. 7A). After that we add a “rule in” operator and a “rule out” operator (see FIG. 7B). Finally we connect the EDB to the join nodes (see FIG. 7C) using the F operator for pushing the facts into the operator net.

These steps are executed for each rule. Then the rules are connected via match operators (depending on the evaluation strategy). When we have a bottom-up evaluation method then the rules are connected bottom-up (from “rule out” operators to rule body operators). For the following example:

| | | |
|---|---|---|
| QUERY query: | FORALL X,Y | <- s(X,Y). |
| RULE rule2: | FORALL X,Y s(X,Y) | <- p(X,Y). |
| RULE rule1: | FORALL X,Y p(X,Y) | <- q(X,Y) AND r(X,Y). |

we would get the operator net depicted in FIG. 8, which is the operator net for bottom-up evaluation.

If we have a top-down evaluation then we also connect the operators top-down, i.e. from the body operators to the rule input operators, using the match operator M, to hand down facts that can be found in the query. This is depicted in FIG. 9.

For clarity the rule compiler examples were simplified. Each evaluation strategy has its own rule compiler (DynamicFiltering, BottomUp, MagicSet, SLD, DBBottomUp, DBMagicSet) and the resulting operator nets (and the operators used in this operator net) are different from each other.

### Operator Net Evaluation

When we have the following program

| | | |
|---|---|---|
| QUERY query: | FORALL X,Y | <- s(X,Y). |
| RULE rule2: | FORALL X,Y s(X,Y) | <- p(X,Y). |
| RULE rule1: | FORALL X,Y p(X,Y) | <- q(X,Y) AND p(X,Y). |

and a bottom-up operator net as depicted in FIG. 10, then the operator net evaluation starts at the F operators and sends facts into the net. In FIG. 10 the F-nodes at the bottom send q-facts and p-facts into the net. These facts reach the join operators &q and &p. These two operations are queued into the operator queue. In a loop the evaluation fetches the first operation of the operator queue and evaluates it until the queue is finally empty. In our example the evaluation of &q and &p produces new facts which flow to the out-node of rule1, from there over the M-nodes to the S-node and the &q node of rule1 and the &p node of rule2. The &q node of rule1 and the &p node of rule2 are join-operations which are again queued into the operator queue.

### Multithreaded Operator Net Evaluation

With the advent of multicore CPUs and multiprocessor systems it is important that program evaluation actually uses the power of multiple cores and CPUs.

The basic idea to evaluate the operator net in a way which uses multiple cores and CPUs is to execute each queued operation in a separate thread. A queued operation is
a join operation,
a connector (a connector is a special built-in operation which accesses external data sources like databases or search engines),
a negation.

As the queued operations can be executed independently of each other it is obvious that we can execute the queued operations concurrently.

The inference engine uses a thread pool of dynamically adapted size. The size of the thread pool depends on the number of available cores/CPUs and their workload. If the operator net evaluator is notified of an operation which should be queued for evaluation it is checked if the operation can be executed immediately in a separate thread or if it needs to be queued until some evaluation thread has been finished.

### Operator Net Debugger

Error diagnosis and debugging the evaluation of programs (especially complex programs with many rules) is very hard (both for the user and for the developer of the reasoning engine).

Basically there are different use cases for debugging tools:
The user of the reasoning engine wants to understand (at a basic level) how her program is evaluated. If the reasoning engine returns unexpected results the user wants to search for errors in her program by examining the way the reasoning engine evaluates the program.
The R&D team of the reasoning engine wants to find errors in the reasoning engine itself (e.g. in the algorithm or in some operator).
Both the users and the developers of the reasoning engine want to understand the performance characteristics of their programs. The reasoning engine must support some sort of information about which rule or which operator consumes most of the time.

The features of the debugging and tracing framework

When the inference engine evaluates a query the debugging framework needs to gather information about
the intensional database (which rules are available),
the extensional database (the data model behind and the features provided by the EDB),
the rule selection (which rules are relevant for evaluating the query),
the rule graph (how are the rules connected to each other),
the program rewriters (which rewriters are applied and what is the input and the output of individual rewriters),
the evaluation strategy of the program,
the dataflow between the operators,
the total evaluation time,
the time needed by single operators.

### Debugging and Tracing Features

The inference engine supports several debugging and tracing options:
Output of the rules used for the program evaluation,
Trace of the evaluation (incl. dataflow between operators and rules),
Statistics about operators (which operators consumes most of the time and how many tuples flow through the operators),
Statistics about the rules (which rules produce most tuples and which rules consumed most of the total evaluation time).

Experience shows that these tracing features greatly simplify error diagnosis and performance optimization in production installations of customers.

### Graphical Rule Debugger

The graphical rule debugger helps users to understand how their programs actually work. This debugger substantially reduces the time for searching for errors in user-level rules.

### The Operator Net Debugging and Tracing Framework

The inference engine evaluates a program by compiling it to an operator net. A major component of the debugging framework is the ability to trace each evaluation step. This is accomplished by a simple idea: Just put a debug operator after each operator which should be traced (see FIG. 11). This way the operator net monitor gets a notification when an operator has been evaluated. The monitor then collects statistics about each operator; e.g. how often the operator is executed during the inferencing process and how many tuples flow through each operator.

This approach has the following benefits:
The normal operators do not become cluttered with tracing and debugging code.
The debugging features have zero overhead if they are turned off.
The debugging features are immediately available even with new or experimental evaluation strategies.
The debugging operators can be added or removed dynamically during the evaluation.

The resulting debugging architecture is shown in FIG. 12. The architecture is simple but powerful as it is easy to add more features on top of the basic framework. It is possible to have multiple operator net monitors for different purposes. All monitors implement a notification API and get notified for evaluation events (e.g. “operatorEvaluated”).

This way, it is straightforward to layer easy-to-use APIs and powerful tools on the basic debugging framework (see FIG. 13).

### The Rule Debugging API Based on the Framework

The operator net monitor receives all kinds of events and collects lots of statistics about each operator and each rule. This information must be accessible via an easy-to-use API in order to develop tools like a graphical rule debugger (see FIG. 13). For this purpose there is an evaluation monitor interface whose implementations receive events about evaluated body literals and rules and not about operators.

### The Tracing Tool

The inference engine is able to trace the whole evaluation process by setting some configuration switches. It can be traced:
Rule statistics: The rule statistics provide information about which rules are most time consuming to evaluate.
Operator statistics: The operator statistics give a good overview over the most time consuming operations. This information is primarily used by rule developers and administrators to optimize programs and single operators.
Dataflow of tuples through the operator net: The main purpose of this tracing feature is to debug the evaluation process. It shows which tuples flow threw which operator.

The debugging and tracing architecture is flexible and powerful. It provides debugging and tracing features with zero overhead when deactivated. The architecture makes it easy to place more advanced features and tools on top of the basic framework.

### Other Solutions of the Object of the Invention

The object of the invention is further achieved by a computer system and a method. Furthermore, the object of the invention is achieved by:
a computer program comprising program means for performing the method according to one of the embodiments described in this description while the computer program is being executed on a computer or on a computer network,
a storage medium, wherein a data structure is stored on the storage medium and wherein the data structure is adapted to perform the method according to one of the embodiments described in this description after having been loaded into a main and/or working storage of a computer or of a computer network.

### BRIEF DESCRIPTION OF THE DRAWINGS

FIG. 1 shows an exemplary system graph;

FIG. 2 shows the exemplary system graph according to FIG. 1 with improved bottom up evaluation;

FIG. 3 data flow of the reasoning kernel;

FIG. 4 sample rule graph;

FIG. 5 sample operator graph;

FIG. 6 main steps of the inference process;

FIG. 7A an operator net representation of a join operation or logical AND;

FIG. 7B the rule of FIG. 7A with IN and OUT operators;

FIG. 7c the rule of FIGS. 7A and 7B with fact retrieval operators;

FIG. 8 a sample operator net for bottom-up evaluation with dynamic filtering;

FIG. 9 a sample operator net for top-down evaluation;

FIG. 10 a sample operator net;

FIG. 11 a join operation with debuggers;

FIG. 12 a schematic drawing of the operation of an operator net monitor for debugging; and

FIG. 13 a schematic drawing of a system architecture for debugging.

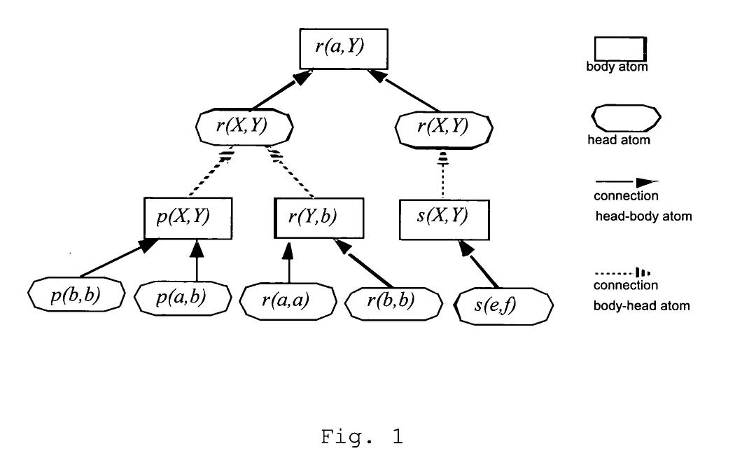

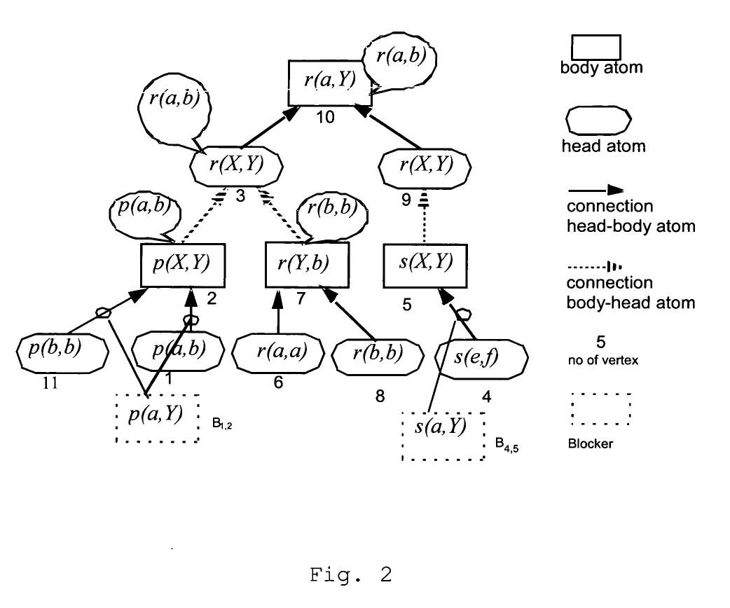

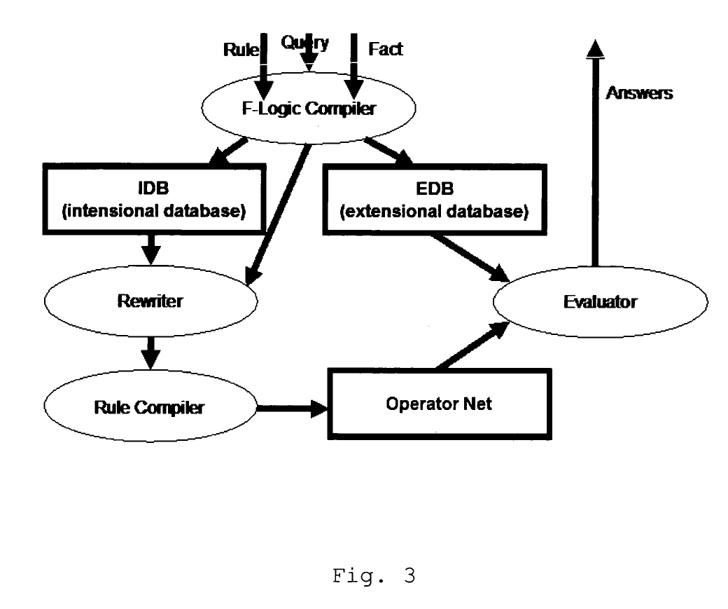

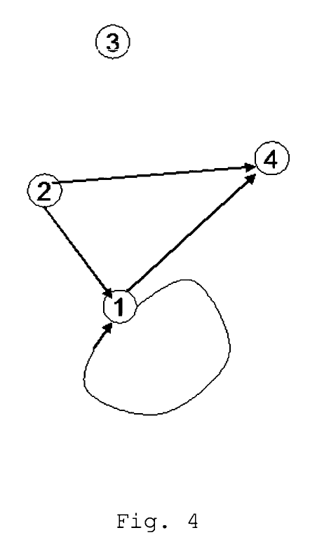

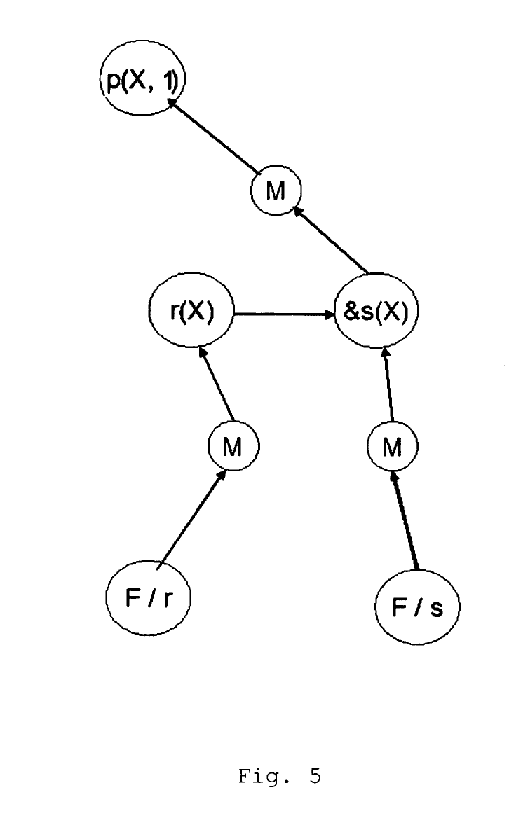

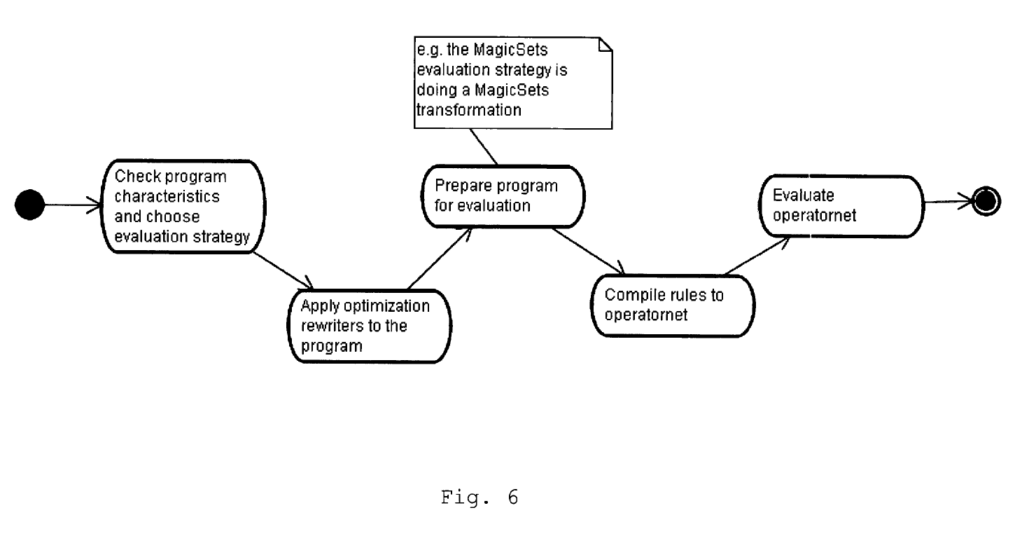

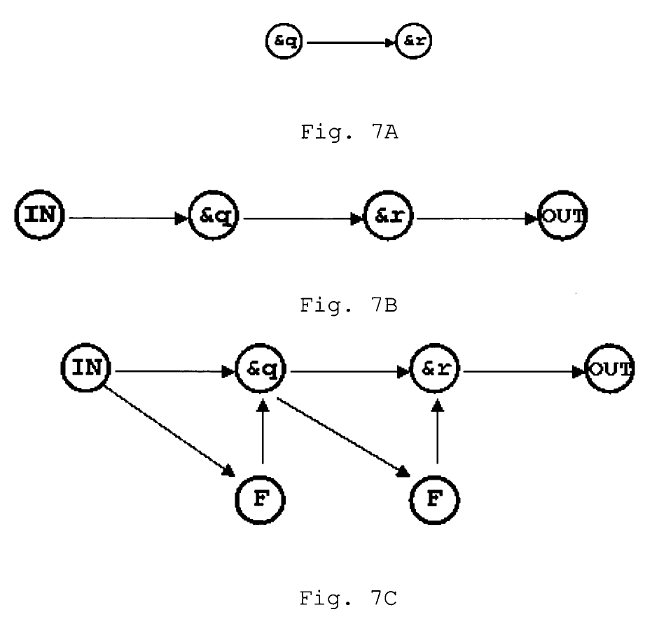

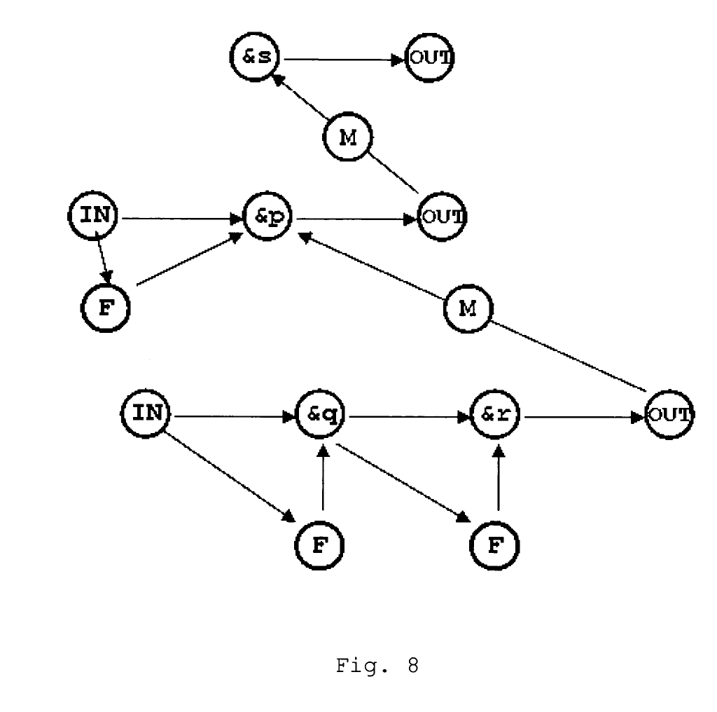

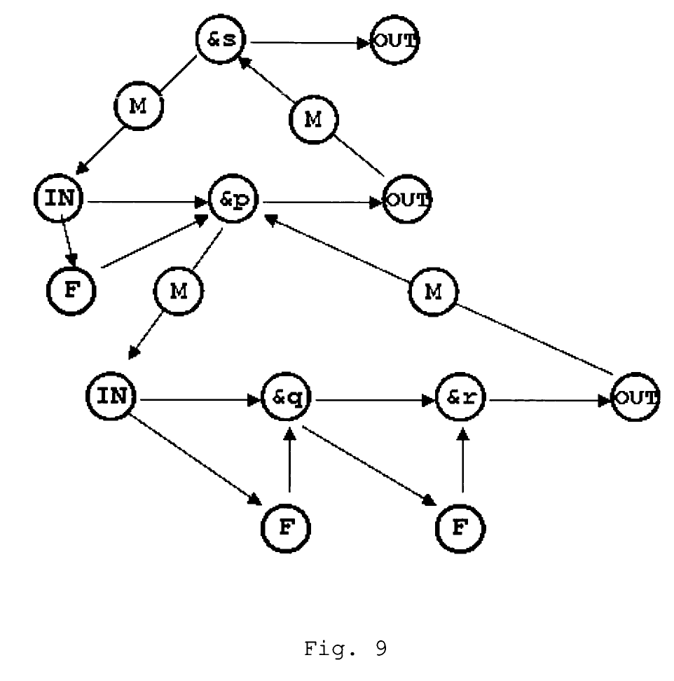

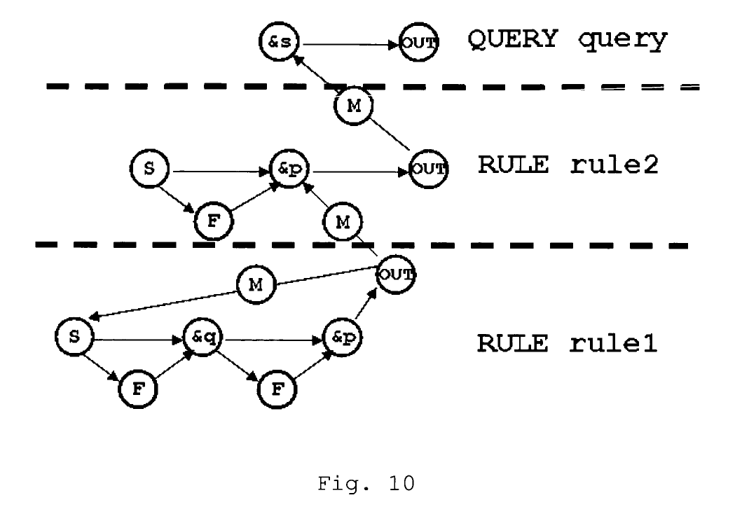

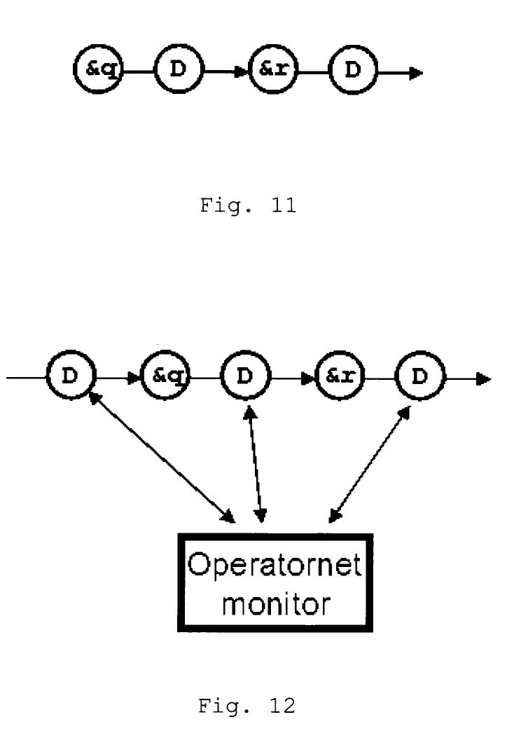

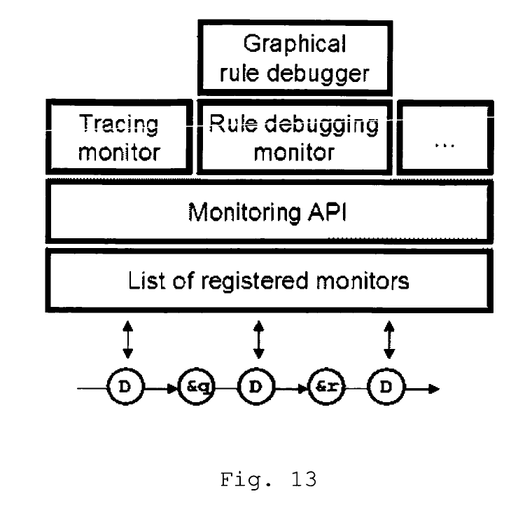

While the present inventions have been described and illustrated in conjunction with a number of specific embodiments, those skilled in the art will appreciate that variations and modifications may be made without departing from the principles of the inventions as herein illustrated, as described and claimed. The present inventions may be embodied in other specific forms without departing from their spirit or essential characteristics. The described embodiments are considered in all respects to be illustrative and not restrictive. The scope of the invention is, therefore, indicated by the appended claims, rather than by the foregoing description. All changes which come within the meaning and range of equivalence of the claims are to be embraced within their scope.

### CITED REFERENCES

J. Angele, G. Lausen: “Ontologies in F-Logic” in S. Staab, R. Studer (Eds.): Handbook on Ontologies in Information Systems. International Handbooks on Information Systems, Springer, 2003, page 29
Beeri C., R. Ramakrishnan: “On the power of magic”; in Proc. Sixth ACM Symp. on Principles of Database Systems, pp. 269-283 (1987)
J. W. Lloyd and R. W. Topor: “Making Prolog more expressive”; Journal of Logic Programming, 1(3):225-240, 1984
T. Przymusinksi: “The well-founded semantics coincides with the three-valued stable semantics”; Fundamenta Informaticae, 13(4):445-464, 1990
J. D. Ullman: “Principles of Database and Knowledge-Base Systems”; vol. I, Computer Sciences Press, Rockville, Md., 1988
J. Ullmann: “Principles of Database and Knowledge-Base Systems”, Volume II, Computer Science Press, 1989
A. Van Gelder, K. A. Ross, and J. S. Schlipf: “The well-founded semantics for general logic programs”; Journal of the ACM, 38(3), pages 620-650, July 1991

1. Method for evaluating a query using inference based on a declarative system of logical rules, comprising the steps of:
a) storing the rules in an intensional database,
a1) each rule having at least a rule body and a rule header;
b) storing facts in an extensional database;
c) rewriting rules in order to optimize the speed of the inferencing;
d) compiling the rules and the query into ah operator net, the operator net comprising:
d1) a graph with operators as nodes of the graph, the operators serving for
d11) retrieving facts from the extensional database;
d12) matching facts and inferencing results with rule bodies;
d13) expressing rule bodies and rule heads;
d14) expressing negations; and
d15) expressing logical AND operations between rule bodies; and
d2) with connections between the operators as edges of the graph; and
e) evaluating the query using the operator net and the extensional database.

2. The method according to claim 1, further comprising:
parallel processing of independent parts of the operator net during the inferencing.

3. The method according to claim 1, further comprising:
storing the interim result of the evaluation of an operator of the operator net in a data structure associated with the operator; and
treating the interim results as sets.

4. The method according to claim 1, further comprising:
inserting a debug operator into the operator net after each operator which is to be monitored, the debug operator being able to transmit data to an observer.

5-6. (canceled)
